(19) United States
(12) Patent Application Publication
(10) Pub. No.: US 2009/0212650 A1
(43) Pub. Date: Aug. 27, 2009

(54) Magnetic rotary device

(76) Inventor: Ramon Freixas Vila, Sarral (ES)

Correspondence Address: OLIFF & BERRIDGE, PLC, P.O. BOX 320850, ALEXANDRIA, VA, 22320-4850, US

(21) Appl. No.: 12/453,146

(22) Filed: Apr. 30, 2009

Related U.S. Application Data
(63) Continuation of application No. 11/713,603, filed on Mar. 5, 2007, now abandoned.
Application No. 11/713,603 is a continuation-in-part of application No. PCT/ES2005/000456, filed on Aug. 9, 2005.

(30) Foreign Application Priority Data
Sep. 7, 2004 (ES) 200402150

(51) Int. Cl. H02K 21/00; H02N 11/00

(52) U.S. Cl. 310/152; 415/916

(57) ABSTRACT

Devices of the invention include a rotor with magnets and a stator with two magnet zones. The end zone of the stator toward which the rotor magnet first approaches has two preferred variants: it can be formed either of one magnet or of a high magnetic permeability material. The other end of the stator is preferably formed of thick magnets.

### CROSS REFERENCE TO RELATED APPLICATIONS

This application is a continuation of application Ser. No. 11/713,603, filed Mar. 5, 2007, which in turn is a continuation-in-part of International Application No. PCT/ES 2005/000456, filed Aug. 9, 2005, which in turn claims priority from Spanish Patent Application No. 200402150, filed Sep. 7, 2004. The entire contents of all prior applications are hereby incorporated by reference.

### BACKGROUND

There are devices with permanent magnets in the rotor and in the stator that create a rotation only using the magnetic force of the magnets. The magnets are attracted to each other to create a rotation; first the rotor magnets and the stator magnets have to be attracted, then this attraction has to diminish so that the rotor can separate from the stator. JP56110483 in FIG. 7 shows the attraction between the magnetic pole of the rotor and the magnetic pole of the stator, but a problem lies in the fact that the rotor magnet cannot escape from the magnetic attraction of the stator.

### SUMMARY

Devices of the present invention resolve the aforementioned problem, because the two magnetic poles of the stator magnet face the rotor, in this way the rotor magnet can escape from the magnetic attraction of the stator.

Devices of the invention comprise a rotor formed of magnets and a stator with two zones. The end zone of the stator toward which the rotor magnet approaches has two preferred variants: it can be formed either of one magnet or of a high magnetic permeability material. The other end of the stator is preferably formed of thick magnets.

### BRIEF DESCRIPTION OF THE DRAWINGS

FIG. 1 shows the pole at the end of the rotor magnet (R) that approaches the stator having the same magnetic polarity as the end of magnet (B).

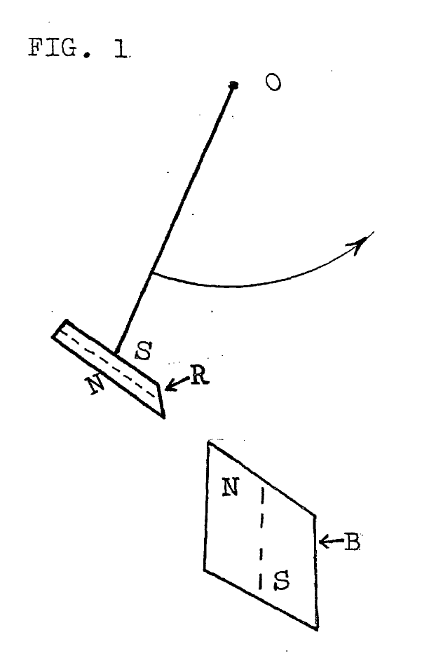

FIG. 2 shows the rotor magnet (R) with an angled edge, and approaching the stator from the magnet (A) end.

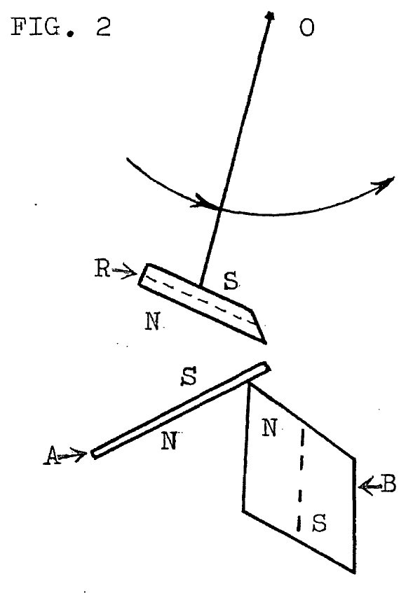

FIG. 3 shows rotor magnet (R) with the same characteristics mentioned in FIGS. 1 and 2. At the end of the stator where it approaches the rotor magnet (R) there is a high magnetic permeability material (M).

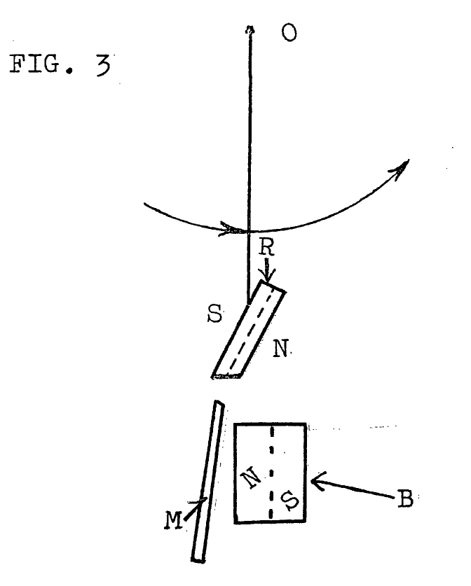

FIG. 4 shows elements of a device with the rotor positioned helicoidally.

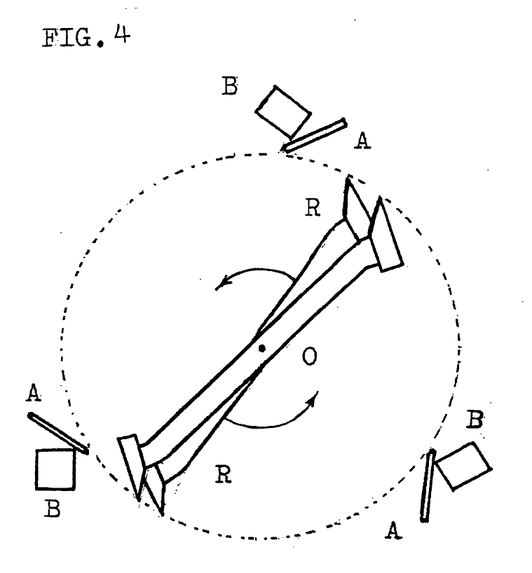

### DETAILED DESCRIPTION OF EMBODIMENTS

### The Rotor

The rotor magnet is situated on an arm that can turn around a shaft in the proximity of the stator. The way of placing the magnet in the rotor will depend on the variant adopted with the stator; the magnet can have an edge forming an angle on the end nearest to the stator, but it is not necessary that the rotor magnet has an angled edge.

The magnetic polarity of the face of the rotor magnet R that approaches the stator will be the same as that of the end of magnet B of the stator. The position of the magnetic poles can vary, for example, if the rotor magnets do not have angled edges but repulsion exists between the magnetic pole on the face of the rotor magnet that approaches the stator, and the magnetic pole of the face which faces up to the ends of the magnet B of the stator.

The rotor magnets may be formed of magnets together one behind the other forming a block.

When the rotor magnet has an angled edge, this rotor magnet should form an oblique angle with a tangent to the circle defined by rotation of the rotor.

### The Stator

There are two preferred variants on the stator; the stator is formed of thick magnets B, at the end that approaches the rotor magnet there is a thin magnet A or a high magnetic permeability material.

The function of the thick magnets B of the stator is to create a repulsion of the rotor magnet. They can have an angled edge on the face so that the magnetic poles on each magnet face up to the rotor. Several magnets can be added so that they form an oblique angled structure.

The two preferred variants of the stator preferably have the same positioning of the magnetic poles as on the thick magnets B, so that when the rotor magnet goes towards the thick magnet B of the stator the two ends that face up to each other are of the same polarity.

In the variant where there is a thin magnet A on the end of the stator, the function of this magnet is to block the repulsion that would take place on the magnetic pole of the rotor magnet when this approaches the thick magnet B of the stator, as mentioned before. The thin magnet A and the thick magnet B that face up to each other will have the same polarity, the other face of the thin magnet A which faces up to the rotor has a magnetic polarity that is attracted to the nearest pole of the rotor magnet. Using this configuration the rotor magnet can approach right to the end of the thin magnet; after this end the poles that interact nearest of the rotor and of the thick magnet B are of the same polarity. The subsequent repulsion will create a movement that will enable the rotor magnet to separate from the stator magnet.

A variant has at the end of the stator that approaches the rotor magnet an element that directs the magnetic field, for example, a metal plate, preferably a high magnetic permeability material (M) that directs the field at the end of the thick magnets B and that allows the attraction of the rotor magnet to the stator.

To form the device the magnets are placed on arms that can rotate around a shaft with the stator on the periphery. The position of the rotor and stator can be varied, for example, a rotor with its arms positioned helicoidally and three blocks of stator.

The rotor magnet (R) is preferably formed of magnets that have an angle at the end nearest the stator. The rotor magnet (R) is preferably placed on an arm at an oblique angle with respect to the radius of the rotor.

The stator magnet (B) has a face with two magnetic poles towards the rotor; when rotor magnet (R) goes towards magnet (B) the magnetic poles on the nearest two ends have the same polarity.

At the end of the magnet (B) in the stator where it approaches the rotor magnet (R) there is a thin magnet (A). The nearest faces that face up of the thin magnet (A) and magnet (B) have the same polarity. The face of magnet (A) of the stator which approaches the rotor will have a different polarity than the end of the rotor magnet that approaches the stator.

The rotor magnets placed on the arms can turn around the shaft (O) when a magnetic interaction is produced between the rotor and the stator. The position of the rotor and the stator can be in a circle or in three dimensions.

Devices of the invention have many uses. As a non-limiting example, they can be used to help the rotation torque that can be used on the pedal of a bicycle.

What is claimed is:

1. A magnetic rotary device, comprising:
a rotor comprising at least one rotor magnet having magnetic poles;
a shaft about which the rotor turns;
a stator comprising at least one stator magnet having two magnetic poles that sequentially face the rotor magnet as the rotor turns; and
a magnet or a high magnetic permeability material at the end of the stator that is first approached by the rotor magnet as the rotor turns, which directs a magnetic field at the end of the stator;
whereby when the rotor magnet approaches the stator a magnetic attraction takes place causing the rotor to turn.

2. The magnetic rotary device as defined in claim 1, wherein the magnetic poles on the rotor magnet and the stator magnet that first approach each other as the rotor turns have the same polarity.
